(19) United States
(12) Patent Application Publication
(10) Pub. No.: US 2014/0034864 A1
(43) Pub. Date: Feb. 6, 2014

(54) COMPOSITION FOR EXTINGUISHING AND/OR INHIBITING FIRES THAT CONTAIN FLUORINE AND/OR PHOSPHORUS

(71) Applicants: Rainer Kern, Stuttgart (DE); Thomas Woehrle, Stuttgart-Feuerbach (DE)

(72) Inventors: Rainer Kern, Stuttgart (DE); Thomas Woehrle, Stuttgart-Feuerbach (DE)

(73) Assignees: Samsung SDI Co., Ltd., Yongin-si, Gyeonggi-do (KR); Robert Bosch GmbH, Stuttgart (DE)

(21) Appl. No.: 13/984,587

(22) PCT Filed: Feb. 6, 2012
(86) PCT No.: PCT/EP12/51930

§ 371 Date: Oct. 21, 2013

(30) Foreign Application Priority Data
Feb. 9, 2011 (DE) 102011003882.5

(51) Int. Cl. A62D 1/00; C09K 21/14

(52) U.S. Cl. CPC A62D 1/0064; C09K 21/14
USPC 252/2; 524/400; 521/93

(57) ABSTRACT

A fire-extinguishing and/or fire-inhibiting composition is based on polymers capable of swelling. In order to bind fumes containing fluorine and/or phosphorous, for example in the event of fires of lithium-ion batteries, the composition includes at least one alkaline-earth carboxylate, in particular calcium carboxylate, of one or more carboxylic acids.

The present invention relates to a fire-extinguishing and/or fire-retardant composition, to a process for production thereof and to the use thereof.

### STATE OF THE ART

Lithium ion batteries, in the event of electrical, mechanical or thermal misuse, or in the event of an unintentional internal or external short circuit, can warm up or heat up with greater or lesser intensity, and even violently go up in flames. The gases which escape and form may, according to the literature reference Armand et al., Nature, 2003, 424, p. 635-636, be toxic and corrosive. More particularly, lithium hexafluorophosphate (LiPF₆) used as a conductive salt can be hydrolyzed with moisture under air, which can form hydrogen fluoride (HF) and phosphorus oxytrifluoride (POF₃).

### DISCLOSURE OF THE INVENTION

The present invention provides a fire-extinguishing and/or fire-retardant composition comprising
at least one swellable polymer and
at least one alkaline earth metal carboxylate of one or more carboxylic acids.

A swellable polymer in context of the present invention may especially be understood to mean a polymer which can absorb a liquid, for example water and/or another solvent, between or on the polymer strands, for example to form a gel or colloid. More particularly, the swellable polymer may be a water-swellable or water-absorbing polymer, or a polymer which can form a gel with water. Such polymer materials are also referred to as superabsorbents or hydrogels.

An alkaline earth metal carboxylate of one or more carboxylic acids may especially be understood to mean an alkaline earth metal carboxylate comprising one or more, identical or different carboxylate groups.

Advantageously, the fire-extinguishing and/or fire-retardant composition can be used for fires of fluorine- and/or phosphorus-containing materials, for example for fires involving hydrogen fluoride and/or phosphorus oxide trifluoride evolution, for example for fires of lithium ion batteries. In the course of these, the swellable polymer can advantageously form gels which reduce the drainage of solvents, especially water, and hence can provide high cooling performance at the seat of the fire. The alkaline earth metal ions of the alkaline earth metal carboxylate can advantageously simultaneously bind hydrogen fluoride (HF) and/or phosphorus oxide trifluoride (POF₃) as nontoxic compounds, especially of sparing solubility, for example as calcium fluoride (CaF₂) and calcium phosphate (Ca₃(PO₄)₂), and remove them from the smoke gas. For instance, it is advantageously possible simultaneously to achieve adequate cooling performance and binding of the toxic emissions in the event of fire, for example of lithium ion batteries. Carboxylate anions advantageously have a lower charge density than chloride ions and therefore do not have a tendency to displace water molecules from the polymer segments. Therefore, the alkaline earth metal carboxylate does not adversely affect the swellability of the swellable polymer, as in the case of the addition of calcium chloride (CaCl₂) to swellable polymers. In addition, alkaline earth metal carboxylates, especially calcium carboxylates, advantageously have a good solubility in water and can also still be removed efficiently after the extinguishment of a fire. Furthermore, carboxylates are not corrosive, especially with respect to aluminum and steel. This is advantageous especially since vehicles, such as motor vehicles and aircraft, may consist in a high proportion of aluminum and steel. Moreover, this makes it possible to store or to stockpile the composition, for example for several years, in metallic vessels. In addition, alkaline earth metal carboxylates, especially calcium carboxylates, advantageously have marked long-term efficacy, meaning that they can be applied as aqueous solutions and retain their fire-retardant action even after drying. Overall, it is thus possible to satisfactorily fight fires, especially of lithium ion batteries.

Preferably, the carboxylic acid/the carboxylate has, or the carboxylic acid/carboxylates of the at least one alkaline earth metal carboxylate each have, a molecular weight of less than 5000 g/mol, especially of less than 1000 g/mol, by way of example of less than 500 g/mol, for example of less than 200 g/mol.

In principle, it is possible to use alkaline earth metal carboxylates of all alkaline earth metal elements. For reasons of cost and due to good compatibility, however, calcium carboxylates and magnesium carboxylates, especially calcium carboxylates, are preferred. Preferably, the at least one alkaline earth metal carboxylate of one or more carboxylic acids comprises or is a calcium carboxylate of one or more carboxylic acids.

The alkaline earth metal carboxylates, especially calcium carboxylates, usable in the inventive compositions preferably contain carboxylate groups whose corresponding carboxylic acids at 23° C. have a pKa of ≦7, for example of ≦6 or of ≦5, and/or of ≧2, for example of ≧3 or of ≧4.

Carboxylic acids may be understood to mean mono-, di-, tri-, tetra-, penta- and polycarboxylic acids. Preference is given to using alkaline earth metal carboxylates of saturated carboxylic acids, i.e. carboxylic acids which do not have any ethylenically unsaturated groups. These are advantageously less reactive than unsaturated carboxylic acids, which can free-radically polymerize and thus lower the storage stability of the composition.

Preferably, the atomic ratio of carbon to alkaline earth metal in the alkaline earth metal carboxylate used should be below 20:1, for example below 12:1 or below 6:1, and/or at least 2:1, for example at least 3:1. The atomic ratio of oxygen to carbon in the alkaline earth metal carboxylate used, especially calcium carboxylate, should preferably be at least 0.85:1, by way of example at least 1:1, for example at least 1.15:1. Alkaline earth metal carboxylates which meet these conditions contain a small amount of carbon in relation to the alkaline earth metal, the carbon having a high mean oxidation state. For instance, the alkaline earth metal carboxylates—because of their stoichiometry—can advantageously themselves only provide a small amount of energy in the course of combustion and produce a large amount of carbon dioxide.

Particularly good results were achieved with monocarboxylic acid anions and calcium cations. Monocarboxylic acids and calcium are advantageously of good availability, nontoxic and inexpensive.

In the context of a further preferred embodiment, the alkaline earth metal carboxylate, especially calcium carboxylate, comprises one or more, identical or different carboxylate groups selected from the group consisting of lactate, gluconate, citrate, oxalate and tartrate. These alkaline earth metal carboxylates have been found to be particularly advantageous in the context of the present invention.

In the context of a further preferred embodiment, the alkaline earth metal carboxylate, especially calcium carboxylate, is selected from the group consisting of calcium lactate gluconate, calcium lactate, calcium gluconate, calcium citrate, calcium oxalate, calcium tartrate and combinations thereof. More particularly, the alkaline earth metal carboxylate, especially calcium carboxylate, may be selected from the group consisting of calcium lactate gluconate, calcium lactate, calcium gluconate, calcium citrate and combinations thereof. These calcium carboxylates have been found to be particularly advantageous alkaline earth metal carboxylates in the context of the present invention.

Preferably, the alkaline earth metal carboxylate, especially calcium carboxylate, is selected from the group consisting of calcium lactate gluconate, calcium lactate, calcium gluconate and combinations thereof. These calcium carboxylates advantageously have a particularly high solubility in water. What is surprising in this context is that the water solubility of calcium lactate gluconate, in which the calcium cation is complexed both by lactate and by gluconate anions, is much higher than the water solubility of pure calcium lactate and pure calcium gluconate, and particular preference is therefore given to calcium lactate gluconate. Moreover, swellable polymers in the presence of calcium lactate gluconate advantageously have good swellability.

The swellable polymer as such may especially have a centrifuge retention capacity of at least 15 g/g. Preferably, the swellable polymer has a centrifuge retention capacity of at least 20 g/g, more preferably of at least 25 g/g. The centrifuge retention capacity can be determined especially by EDANA (European Disposables and Nonwovens association) recommended test method No. 441.2-02 ‘Centrifuge retention capacity’.

The production of swellable polymers is described, for example, in the monograph ‘Modern Superabsorbent Polymer Technology’, F. L. Buchholz and A. T. Graham, Wiley-VCH, 1998 or in Ullmann's Encyclopedia of Industrial Chemistry, 6^{th} edition, volume 35, pages 73 to 103.

For preparation of swellable polymers, hydrophilic, ethylenically unsaturated monomers can be converted in the presence of crosslinkers to a base polymer. The polymerization can, as described, for example, in publication U.S. Pat. No. 5,041,496, also be performed in the presence of a suitable graft base. The reaction can be performed, for example, as a free-radical solution polymerization or inverse suspension polymerization, especially as a free-radical solution polymerization.

Suitable monomers for preparation of the swellable polymers are, for example, ethylenically unsaturated carboxylic acids, such as acrylic acid, methacrylic acid, maleic acid, fumaric acid and itaconic acid, or derivatives thereof, such as acrylamide, methacryl-amide, acrylic esters and methacrylic esters. Particularly preferred monomers are acrylic acid and methacrylic acid.

Preferably, the swellable polymer has been crosslinked. For this purpose, the polymerization can be performed in the presence of compounds having at least two polymerizable groups which can be free-radically polymerized into the polymer network.

Suitable crosslinkers are, for example, ethylene glycol dimethacrylate, diethylene glycol diacrylate, allyl methacrylate, trimethylolpropane triacrylate, triallyl-amine, tetraallyloxyethane, as described, for example, in publication EP 530 438 A, di- and triacrylates, as described, for example, in publications EP 547847, EP 559476, EP 632068, WO 93/21237, WO 03/104299, WO 03/104300, WO 03/104301 and DE 10355401, mixed acrylates which, as well as acrylate groups, comprise further ethylenically unsaturated groups, as described, for example, in publications DE 10331456 and DE 10355401, or crosslinker mixtures, as described, for example, in publications DE 19543368, DE 19646484, WO 90/15830 and WO 02/32962. Preferably, the polymerizable groups are selected from the group of allyl, acryloyloxy and methacryloyloxy. Allyl ether and allylamine groups, especially allyl ether groups, are especially preferred.

The crosslinkers may contain two, three, four or more, preferably two, three or four, more preferably three or four, polymerizable groups.

The polymerizable groups in the crosslinker may be the same or different; for example, the crosslinker may contain at least one acrylic ester group and at least one allyl ether group, at least one acrylic ester group and at least one allylamine group, at least one methacrylic ester group and at least one allyl ether group, at least one methacrylic ester group and at least one allylamine group, at least two acrylic ester groups or at least two methacrylic ester groups, preferably at least one allyl ether group and at least one allylamine group or at least two allylamine groups, more preferably at least two allyl ether groups.

Preferred crosslinkers are ethylene glycol diallyl ether, diethylene glycol diallyl ether, polyethylene glycol diallyl ether, propylene glycol diallyl ether, dipropylene glycol diallyl ether, polypropylene glycol diallyl ether, tetraallyloxyethane, trimethylolpropane diallyl ether, trimethylolpropane triallyl ether, pentaerythrityl triallyl ether and pentaerythrityl tetraallyl ether, especially tetrallyloxyethane, trimethylolpropane diallyl ether, trimethylolpropane triallyl ether, pentaerythrityl triallyl ether and pentaerythrityl tetraallyl ether.

The preparation of a suitable base polymer and further suitable hydrophilic ethylenically unsaturated monomers and crosslinkers are described in publications DE 19941423, EP 686650, WO 01/45758 and WO 03/104300.

The reaction is preferably performed in a kneader, as described, for example, in publication WO 01/38402, or in a belt reactor, as described, for example, in publication EP 955086.

Preferably, from ≧25 mol % to ≦85 mol %, preferably from ≧40 mol % to ≦75 mol %, more preferably from ≧51 mol % to ≦69 mol %, even more preferably from ≧55 mol % to ≦65 mol %, especially preferably from ≧53 mol % to ≦63 mol %, very especially preferably from ≧59 mol % to ≦61 mol %, of the acid groups, especially carboxyl groups, of the swellable polymer have been neutralized.

The neutralizing agents used may, for example, be ammonia, amines such as ethanolamine, diethanolamine, triethanolamine or dimethylaminoethanolamine, preferably alkali metal hydroxides, alkali metal oxides, alkali metal carbonates or alkali metal hydrogencarbonates and/or alkaline earth metal carboxylates, alkaline earth metal hydroxides, alkaline earth metal oxides, especially those which react with water to give alkaline earth metal hydroxides, alkaline earth metal carbonates or alkaline earth metal hydrogencarbonates, and mixtures thereof. Preference is given here to calcium as the alkaline earth metal and/or to sodium and/or potassium as alkali metals. Particular preference is given to calcium hydroxide, calcium carbonate, calcium hydrogencarbonate and mixtures thereof, and/or potassium hydroxide, potassium carbonate, potassium hydrogencarbonate and mixtures thereof. It is also possible to use calcium carboxylates of one or more carboxylic acids, preferably having a molar mass of less than 1000 g/mol, for example of less than 500 g/mol, especially of less than 200 g/mol. Very particular preference is given to calcium hydroxide.

At least 15 mol %, preferably at least 33 mol %, more preferably at least 80 mol %, most preferably at least 95 mol %, of the neutralized acid groups, especially carboxyl groups, of the swellable polymer have potassium, sodium and/or calcium ions, especially calcium ions, as the counterion.

In the context of a further embodiment, the composition comprises at least one swellable polymer having acid groups, especially carboxyl groups and/or sulfo groups, where at least some of the acid groups, especially carboxyl groups and/or sulfo groups, have been neutralized with alkaline earth metal ions. Alkaline earth metal ions have the advantage here that they can bind hydrogen fluoride and/or phosphorus oxide trifluoride (POF₃). More particularly, the at least one swellable polymer may comprise or be the at least one alkaline earth metal ion-neutralized swellable polymer.

In the context of a preferred embodiment, the acid groups, especially carboxyl groups, have been at least partly neutralized with calcium ions. Calcium ions have the advantage here that they can bind hydrogen fluoride and/or phosphorus oxide trifluoride (POF₃). More particularly, the at least one swellable polymer may comprise or be the at least one calcium ion-neutralized, swellable polymer.

Typically, the neutralization is achieved by mixing in the neutralizing agent in solid form or as an aqueous solution.

The swellable polymer, especially neutralized swellable polymer, can be dried with a belt drier or roller drier, for example until the residual moisture content is below 10% by weight, for example below 5% by weight, the water content being determinable by EDANA (European Disposables and Nonwovens Association) recommended test method No. 430.2-02 ‘Moisture content’.

After drying, the swellable polymer can be ground and sieved, grinding typically being accomplished by using roll mills, pinned disk mills or vibratory mills.

The particle size of the swellable polymer may especially be ≦1000 μm, for example ≦900 μm or ≦800 μm, and/or ≧100 μm, for example ≧150 μm or ≧200 μm. For example, the swellable polymer may have a particle size (sieve cut) of 106 μm to 850 μm. The particle size can be determined by EDANA (European Disposables and Nonwovens Association) recommended test method No. 420.2-02 ‘Particle size distribution’.

The base polymer may especially be surface postcrosslinked. Postcrosslinkers suitable for this purpose are compounds containing at least two groups which can form covalent bonds with the acid groups of the polymer. Suitable compounds for polymers having carboxyl groups are, for example, alkoxysilyl compounds, polyaziridines, polyamines, polyamido amines, di- or polyglycidyl compounds as described in EP 083022, EP 543303 and EP 937736, di- or poly-functional alcohols as described in DE 3314019, DE 3523617 and EP 450922, or beta-hydroxyalkyl amides as described in DE 10204938 and U.S. Pat. No. 6,239,230. Additionally described as suitable surface postcrosslinkers are cyclic carbonates in DE 4020780, oxazolidone and derivatives thereof, such as 2-hydroxy-ethyl-2-oxazolidone in DE 19807502, bis and poly-2-oxazolidinones in DE 19807992, oxotetrahydro-1,3-oxazine and derivatives thereof in DE 19854573, N-acyl-2-oxazolidones in DE 19854574, cyclic ureas in DE 10204937, bicyclic amide acetals in DE 10334584, oxetanes and cyclic ureas in EP 1199327, and morpholine-2,3-dione and derivatives thereof in WO 03/031482.

The postcrosslinking can be performed, for example, in such a way that a solution of the surface postcrosslinker is sprayed onto the polymer. This may be followed by thermal drying, in which case the crosslinking reaction can take place either before or during the drying. The postcrosslinker solution is preferably sprayed on in mixers with moving mixing tools, such as a screw mixer, paddle mixer, disk mixer, plowshare mixer or shovel mixer, especially a vertical mixer, for example a plowshare mixer or shovel mixer. Suitable mixers are, for example, Lodige mixers, Bepex mixers, Nauta mixers, Processall mixers and Schugi mixers. The thermal drying can be performed, for example, in contact driers, such as a paddle drier, especially a disk drier. Suitable driers are, for example, Bepex driers and Nara driers. It is also possible to use fluidized bed driers. The drying can be effected in the mixer itself, for example by heating the jacket or blowing in warm air. However, it is also possible for a drier, for example a staged drier, a rotary tube oven or a heatable screw, to be connected downstream. However, it is also possible to use an azeotropic distillation as the drying process. The drying temperature may, for example, be within a range from ≧50° C. to ≦250° C., especially from ≧50° C. to ≦200° C. or ≦150° C. The residence time at this temperature in the reaction mixer or drier may, for example, be ≦30 minutes, especially ≦10 minutes.

The base polymer may especially be lightly postcrosslinked, i.e. with a postcrosslinker concentration of ≦0.3% by weight, especially of ≦0.2% by weight, or of ≦0.15% by weight or of ≦0.1% by weight, based in each case on the base polymer. In order to achieve sufficient postcrosslinking, preferably ≧0.01% by weight, especially ≧0.025% by weight, or ≧0.05% by weight, of postcrosslinker is used, based in each case on the base polymer.

Lightly postcrosslinked swellable polymers may have, for example, an absorption under a pressure of 2070 Pa (0.3 psi) of ≦25 g/g, by way of example of ≦23 g/g, for example of ≦21 g/g, and/or an absorption under a pressure of 4830 Pa of ≦18 g/g, for example of ≦15 g/g or of ≦12 g/g. The absorption under pressure can especially be determined by EDANA (European Disposables and Nonwovens Association) recommended test method No. 442.2-02 ‘Absorption under pressure’.

The postcrosslinking can adjust the tackiness of the swellable polymer. In the case of very low postcrosslinking, the particles in the swollen state may stick to one another and have a tendency to cake. In the case of very high postcrosslinking, the swollen polymers may lose their tackiness. For use in firefighting and/or fire retardance, tackiness may be advantageous, this being optimized to the effect that the particles can stick to the combustible material to be protected without further auxiliaries.

In the context of a further preferred embodiment, the composition comprises at least one at least partly alkaline earth metal ion-neutralized, especially crosslinked, polymer based on acrylic acid and/or acrylic acid derivatives. For example, the swellable polymer may comprise or be an at least partly alkaline earth metal ion-neutralized, especially crosslinked, polyacrylic acid. More particularly, the at least one swellable polymer may comprise or be the alkaline earth metal ion-neutralized polymer based on acrylic acid and/or acrylic acid derivatives. Alkaline earth metal ion-neutralized polymers based on acrylic acid and/or acrylic acid derivatives have been found to be especially advantageous for fighting and/or retarding fires of fluorine- and/or phosphorus-containing materials.

In the context of a further preferred embodiment, the composition comprises at least one at least partly alkaline earth metal ion-neutralized, especially crosslinked, acrylic acid-acrylamide copolymer. More particularly, the at least one swellable polymer may comprise or be the alkaline earth metal ion-neutralized acrylic acid-acrylamide copolymer. Such swellable polymers have been found to be particularly advantageous for fighting and/or retarding fires of fluorine- and/or phosphorus-containing materials.

In a composition containing alkaline earth metal carboxylate, especially calcium carboxylate, the swellable polymer may especially have a centrifuge retention capacity of at least 5 g/g. Preferably, the swellable polymer in a composition containing alkaline earth metal carboxylate, especially calcium carboxylate, has a centrifuge retention capacity of at least 10 g/g, more preferably of at least 15 g/g. The determination of centrifuge retention capacity can especially be performed here analogously to EDANA (European Disposables and Nonwovens Association) recommended test method No. 441.2-02 ‘Centrifuge retention capacity’ with a 10 percent by weight aqueous alkaline earth metal carboxylate solution, especially calcium carboxylate solution.

The weight ratio of swellable polymer to alkaline earth metal carboxylate may, for example, be within a range from 100:1 to 1:1000, by way of example from 1:1 to 1:100, for example from 1:2 to 1:50 or from 1:4 to 1:25 or from 1:8 to 1:15. In the case of an excessively low proportion of swellable polymer, the immediate extinguishing action may be too low. In the case of a high proportion of swellable polymer, the viscosity rises. In the case of use of the composition as a coating, however, this may be advantageous, and therefore the swellable polymer for this purpose may also be present in higher proportions than the above in the composition.

In the context of a further preferred embodiment, the composition (further) comprises water. In this case, water may be added to the composition before or during use for firefighting and/or fire retardance. For example, an aqueous composition can be produced and kept ready for a deployment. However, it is also possible to only produce the aqueous composition during a deployment by dilution with water. The inventive composition, however, is also suitable as a fire-retardant coating. The water content may, for example, be ≧55% by weight, for example ≧65% by weight or ≧75% by weight, or ≧85% by weight, and/or ≦95% by weight, for example ≦90% by weight, based in each case on the total weight of the composition.

In the context of a further preferred embodiment, the composition (further) comprises at least one antiseparation agent and/or thickener. The antiseparation agent and/or thickener can advantageously increase the storage stability of an aqueous composition and prevent sedimenting of the swollen polymer. For some applications, it is advantageous when the composition comprising antiseparation agent and/or thickener and water is still pumpable.

Suitable antiseparation agents and/or thickeners are natural organic thickeners, such as agar-agar, carrageenan, tragacanth, xanthan, gum arabic, alginates, pectins, polyoses, guar flour, carob flour, starch, dextrins, gelatins or casein, modified organic natural substances, such as carboxymethyl cellulose, fully synthetic organic thickeners, such as polyacrylic compounds, polymethacrylic compounds, vinyl polymers, polycarboxylic acids, polyethers, polyimines or polyamides, and inorganic thickeners, such as polysilicas or clay minerals.

The concentration of the antiseparation agent and/or thickener in a water-containing composition may, for example, be ≦2% by weight, by way of example ≦1% by weight or ≦0.5% by weight, and/or ≧0.01% by weight, by way of example ≧0.5% by weight or ≧0.1% by weight, based in each case on the total weight of the water-containing composition.

The viscosity of a water-containing composition may, for example, be ≧100 mPas, for example ≧200 mPas or ≧500 mPas, and/or ≦5000 mPas, for example ≦2000 mPas or ≦1000 mPas.

In addition, the inventive composition may also comprise biocides. Biocides can advantageously increase the storage stability especially of a water-containing composition.

In the context of a further preferred embodiment, the composition (further) comprises at least one foaming agent. Suitable foaming agents are, for example, multipurpose foaming agents, protein foaming agents and fluorosurfactant foaming agents, especially multipurpose foaming agents and fluorosurfactant foaming agents. In the case of use of the inventive composition, the foam is typically obtained by mixing in air. The combination of a swellable or swollen polymer with a foam is particularly advantageous in the extinguishing of combustible liquids, since the oxygen supply can be stopped by the foam in the course of extinguishing combustible liquids with extinguishing foam. The swellable or swollen polymer can additionally cool ignitable surfaces to such an extent that ignition is no longer possible.

For example, the inventive composition may comprise:
≧0.1% by weight to ≦10% by weight, for example ≧0.5% by weight to ≦5% by weight or ≧0.8% by weight to ≦3% by weight, of swellable, optionally alkaline earth metal ion-neutralized, especially calcium ion-neutralized, polymers and
≧1% by weight to ≦65% by weight, for example ≧5% by weight to ≦40% by weight or ≧5% by weight to ≦12% by weight, of alkaline earth metal carboxylates, especially calcium carboxylates, and
optionally ≧0.01% by weight to ≦2% by weight, for example ≧0.05% by weight to ≦1% by weight or ≧0.1% by weight to ≦0.5% by weight, of antiseparation agents and/or thickeners,
≧30% by weight to ≦95% by weight, for example ≧55% by weight to ≦92% by weight or ≧85% by weight to ≦90% by weight of water,
optionally at least one foaming agent, and
optionally at least one biocide,
optionally at least one colorant, and
optionally at least one opacifying aid,
   especially where the sum of the components adds up to 100 percent by weight.

With regard to further features and advantages, reference is made here explicitly to the elucidations in connection with the process according to the invention, the inventive use, the inventive apparatuses, the examples and the description of the FIGURE.

The present invention further provides a process for producing an inventive fire-extinguishing and/or fire-retardant composition.

An inventive composition can especially be produced by mixing the components, especially at least one swellable polymer and at least one alkaline earth metal carboxylate, especially calcium carboxylate, of one or more carboxylic acids, especially having a molecular weight of less than 5000 g/mol, especially of less than 1000 g/mol, by way of example of less than 500 g/mol, for example of less than 200 g/mol. In principle, the sequence of mixing is as desired.

In the context of one embodiment of the process, at least one swellable polymer at least partly neutralized with alkaline earth metal ions, especially calcium ions, and at least one alkaline earth metal carboxylate are mixed.

In the context of a further embodiment of the process, at least one swellable polymer optionally at least partly neutralized with alkaline earth metal ions, especially calcium ions, at least one alkaline earth metal carboxylate and at least one solvent, for example water, are mixed. Preference is given to producing solvent-containing compositions by initially charging the solvent(s) and mixing in the other components. Preferably, the at least one swellable, optionally alkaline earth metal ion-neutralized polymer, the at least one alkaline earth metal carboxylate and optionally the at least one antiseparation agent and/or thickener are added last. However, it is also possible to add the at least one foaming agent last. This can be done, for example, during a deployment, for example by means of a suitable Venturi nozzle.

The neutralization of the acid groups, especially carboxyl groups, of the swellable polymer can be performed before the polymerization, for example at the stage of a monomer solution, or after the polymerization. It is also possible to perform some of the neutralization at the stage of the monomer solution and to establish the desired final degree of neutralization after the polymerization.

For example, it is possible to provide monomers which are polymerizable to give a swellable polymer and which in each case have at least one acid group which does not take part in the polymerization reaction, especially carboxyl group.

These acid groups, especially carboxyl groups, may first be at least partly neutralized, and the monomers can be polymerized later to give the swellable polymer. This may involve neutralizing a monomer solution by mixing in the neutralizing agents elucidated above.

Alternatively or additionally, the monomers may first be polymerized to give the swellable polymer and the acid groups, especially carboxyl groups, may be at least partly neutralized at a later stage. For example, the polymer may be comminuted mechanically, for example by means of a meat grinder, and the neutralizing agent is sprayed on, scattered over or poured on and then mixed in carefully. For homogenization, the polymer can be gelated or swollen several times.

Preference is given to performing the neutralization at least partly after the polymerization.

For example, ≧40 mol %, preferably ≧10 mol % to ≦30 mol %, more preferably ≧15 mol % to ≦25 mol %, of the acid groups, especially carboxyl groups, of the swellable polymer to be prepared may be neutalized before the polymerization by adding a portion of the neutralizing agent directly to a monomer solution. The desired final degree of neutralization can then be established later, after the polymerization.

In the context of a further embodiment of the process, at least one swellable polymer having acid groups, especially carboxyl groups, is provided, wherein the acid groups, especially carboxyl groups, have been at least partly neutralized with alkali metal ions, the alkali metal ions being exchanged at least partly for alkaline earth metal ions, especially calcium ions, by means of ion exchangers.

With regard to further features and advantages, reference is made here explicitly to the elucidations in context with the inventive composition, the inventive use, the inventive apparatuses, the examples and the description of the FIGURE.

The present invention further provides for the use of an inventive composition for firefighting, especially as an extinguishant, and/or for production of a fire-retardant coating. More particularly, the inventive composition can be used for fighting and/or inhibiting fires of fluorine- and/or phosphorus-containing materials, for example for fires involving hydrogen fluoride and/or phosphorus oxide trifluoride evolution, for example for fires of lithium ion batteries, either with a rigid housing (hard case) or with a flexible package (soft package, pouch cells, lithium-polymer cells).

More particularly, the inventive composition can be used in a stationary or mobile extinguishing apparatus, for example in a high-pressure nebulization extinguishing apparatus or a manual fire extinguisher, especially in or for a vehicle, in or for a lithium ion battery, in or for a lithium ion battery manufacturing, assembly and/or testing plant, and/or in or for a lithium ion battery vessel, for example transport vessel.

A stationary extinguishing apparatus may be understood to mean, for example, apparatuses installed in a fixed manner in a building, a plant, a machine or a vehicle, more particularly in order to fight and/or inhibit a fire in the part of the building, machine or vehicle in which the apparatus is installed.

A mobile extinguishing apparatus may be understood to mean, for example, apparatuses which are portable and/or mobile, more particularly in order to be transported to the site of the fire in the event of fire.

The terms “stationary” and “mobile” thus relate more particularly to the circumstances of location between the extinguishing apparatus and the site of fire. An extinguishing device which is installed in a fixed manner in a vehicle and is designed for fighting and/or inhibiting a fire in the vehicle can therefore be understood as a stationary extinguishing apparatus, even though the vehicle as such is mobile, and an extinguishing device which is installed in a fixed manner in a vehicle and which is designed for controlling and/or inhibiting fires at sites outside the vehicle, for which the extinguishing apparatus can be transported by means of the vehicle, as in the case of a firefighting appliance, can be understood as a mobile extinguishing apparatus.

An extinguishing apparatus in or for a vehicle, in or for a lithium ion battery, in or for a lithium ion battery manufacturing, assembly and/or testing plant, and/or in or for a lithium ion battery vessel can be filled, for example, with an inventive composition, from which the composition can be dispensed in the event of danger.

Because of the swellable polymer, an inventive aqueous composition can advantageously have lower vaporization and hence stronger cooling action than an aqueous alkaline earth metal salt solution lacking swellable polymers.

It is possible to use an inventive composition to coat, for example, vessels, such as housings, for lithium ion batteries and/or vehicle components, for example chassis components. Building materials and/or components coated with an inventive composition, compared to uncoated building materials and/or components, may have a much higher level of nonflammability and additionally have the property of at least partly binding decomposition products of fluorine- and/or phosphorus-containing materials.

An aqueous composition can be kept ready, for example, for a firefighting deployment. However, it is also possible to produce an aqueous composition only during a firefighting deployment by dilution with water.

An inventive composition, even in the dry state, may bring about distinctly retarded ignition on the surface of an inflammable material coated with the composition, a distinct reduction in smoke evolution and virtually no afterglow.

At the same time, it is advantageously possible to remove an inventive composition after use by washing with water.

In addition, an inventive composition may advantageously be very frost-resistant. For example, it is possible to obtain an inventive aqueous composition which can still be sprayed at −30° C. and is a high-viscosity but still plastic material at −60° C. As a result, bursting of the vessels can be avoided even at very low temperatures.

Furthermore, an inventive composition may be noncorrosive, especially with respect to aluminum and steel. This is especially advantageous since vehicles such as motor vehicles and aircraft may consist in a high proportion of aluminum and steel. In addition, this offers the possibility of storing or stockpiling the composition in metallic vessels, for example for several years.

With regard to further features and advantages, reference is made here exclusively to the elucidations in connection with the inventive composition, the process according to the invention, the inventive apparatuses, the examples and the description of the FIGURE.

The present invention further provides a lithium ion battery comprising an inventive composition. The inventive composition can either be designed into the battery or be stored in the battery, or else be introducible, for example sprayable, into the battery, especially the battery housing, for example into a double-wall battery housing.

With regard to further features and advantages, reference is made here exclusively to the elucidations in connection with the inventive composition, the process according to the invention, the inventive apparatuses, the examples and the description of the FIGURE.

The present invention further provides a stationary or mobile extinguishing apparatus, especially in or for a vehicle, in or for a lithium ion battery, in or for a lithium ion battery manufacturing, assembly and/or testing plant, and/or in or for a lithium ion battery vessel, for example transport vessel, comprising an inventive fire-extinguishing and/or fire-retardant composition.

With regard to further features and advantages, reference is made here exclusively to the elucidations in connection with the inventive composition, the process according to the invention, the inventive use, the examples and the description of the FIGURE.

### DRAWING AND EXAMPLES

Further advantages and advantageous configurations of the subject matter of the invention are illustrated by the drawing and examples and elucidated in the description which follows. It should be noted that the drawing and examples are merely of descriptive character and are not intended to restrict the invention in any way. The FIGURE shows:

FIG. 1 a schematic view of a macromolecular solution of a swellable polymer.

FIG. 1 gives a schematic illustration of a swellable polymer swollen in a solvent. The polymer chains 1 of the polymer form a knot 2 having a knot volume. The solvent present between the polymer chains 1 can be described as bound solvent 3. The solvent present between the polymer knots 2 can be described as free solvent 4.

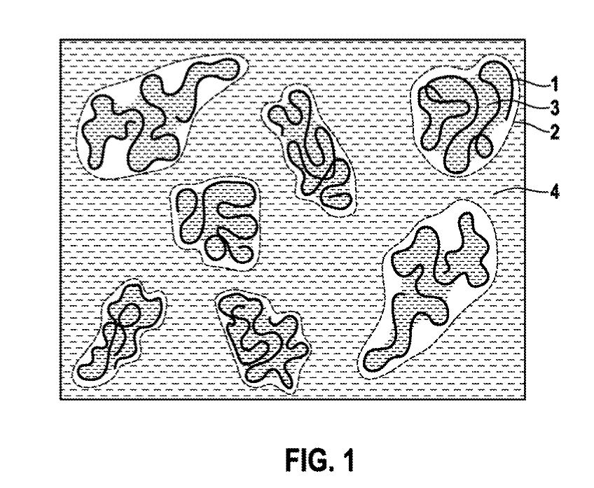

### Example 1

A plowshare kneader having a capacity of five liters was initially charged with 1000 g of deionized water and 810 g of acrylic acid and inertized by passing nitrogen through for 20 minutes. Then the mixture was neutralized with a likewise inertized potassium hydroxide solution. Subsequently, pentaerythrityl triallyl ether and sorbitan monolaurate were added. The polymerization was initiated by adding an aqueous persulfate- and ascorbic acid-containing solution at room temperature. The hydrogel obtained was post-neutralized with potassium hydroxide solution and dried in an air circulation drying cabinet.

The dried base polymer was ground and sieved to 106 to 850 μm. 100 g of the dried base polymer were initially charged in a laboratory mixer which was equipped with an attachment having blunt mixing blades. At moderate speed, ethylene glycol diglycidyl ether dissolved in 1,2-propanediol and water was then added gradually while stirring by means of an injection syringe through a hole in the lid of the mixing attachment, in order to wet the base polymer with maximum homogeneity. The moistened polymer was homogenized by stirring, heat treated at 150° C. in an air circulation drying cabinet for 60 minutes and sieved in an 850 μm sieve.

### Example 2a

A fire-extinguishing and/or fire-retardant composition was produced by stirring 2% by weight of swellable polymer according to Example 1, 3.5% by weight of calcium gluconate, 0.2% by weight of xanthan, 0.12% by weight of polyethylene glycol (solubilizer) into 1 liter of water. This composition had better swellability than an analogous composition comprising calcium chloride rather than calcium gluconate.

### Example 2b

A fire-extinguishing and/or fire-retardant composition was produced by stirring 2% by weight of swellable polymer according to Example 1, 6.5% by weight of calcium lactate, 0.2% by weight of xanthan, 0.12% by weight of polyethylene glycol (solubilizer) into 1 liter of water. This composition had better swellability than an analogous composition comprising calcium chloride rather than calcium lactate.

### Example 2c

A fire-extinguishing and/or fire-retardant composition was produced by stirring 2% by weight of swellable polymer according to Example 1, 20% by weight of calcium lactate gluconate, 0.2% by weight of xanthan, 0.12% by weight of polyethylene glycol (solubilizer) into 1 liter of water. This composition had better swellability than an analogous composition comprising calcium chloride rather than calcium lactate gluconate.

### Example 2d

A fire-extinguishing and/or fire-retardant composition was produced by stirring 2% by weight of an extinguishant sold under the Firesorp trade name by Stockhausen Evonik, 3.5% by weight of calcium gluconate, 0.2% by weight of xanthan, 0.12% by weight of polyethylene glycol (solubilizer) into 1 liter of water. According to the safety data sheet from Stockhausen Evonik, Firesorp consists essentially of a swellable, partly sodium ion-neutralized polymer. This composition had better swellability than an analogous composition comprising calcium chloride rather than calcium gluconate.

### Example 2e

A fire-extinguishing and/or fire-retardant composition was produced by stirring 2% by weight of Firesorp from Stockhausen Evonik, 6.5% by weight of calcium lactate, 0.2% by weight of xanthan, 0.12% by weight of polyethylene glycol (solubilizer) into 1 liter of water. This composition had better swellability than an analogous composition comprising calcium chloride rather than calcium lactate.

### Example 2f

A fire-extinguishing and/or fire-retardant composition was produced by stirring 2% by weight of Firesorp from Stockhausen Evonik, 20% by weight of calcium lactate gluconate, 0.2% by weight of xanthan, 0.12% by weight of polyethylene glycol (solubilizer) into 1 liter of water. This composition had better swellability than an analogous composition comprising calcium chloride rather than calcium lactate gluconate.

### Fire Tests:

Fire tests with accompanying analysis were conducted by way of example on commercial lithium ion softpack/pouch cells (nominal capacity 4 Ah) from Kokam. For this purpose, the lithium ion cells were connected to form a module by series connection and overloaded and deliberately driven to “thermal runaway” in order to cause a fire. After ignition of the first lithium ion cell (with appearance of flames) in the module, various extinguishants were used for extinguishment, the behavior of the fire was assessed and the extinguishing water was analyzed for free fluoride and phosphates. In the fire tests, the extinguishants examined were carbon dioxide, metal fire powder for lithium and magnesium fires (quartz sand), water, a 2% by weight aqueous Firesorp solution, a combination of a 2% by weight aqueous Firesorp solution and a 1.5% by weight aqueous calcium chloride solution, and the compositions from Examples 2a to 2f.

In the case of use of carbon dioxide as extinguishant, the air and hence the oxygen were displaced only briefly. In addition, the cooling performance appeared inadequate, such that after the ignition of the first cell the ignition of adjacent cells could not be prevented. Significant emission of smoke gas was also observed.

In the case of use of metal fire powder for lithium and magnesium fires, more particularly quartz sand, as an extinguishant, significant emission of smoke gas was likewise observed.

In the case of use of water as the extinguishant, the extinguishing water flowed away or evaporated after the extinguishing of the first cell. Sufficient cooling action was unachievable with water as the extinguishant, and so the ignition of neighboring cells could not be prevented. In addition, significant emission of smoke gas was observed. Fluoride and phosphate ions were detectable in the extinguishing water.

In the case of use of the aqueous Firesorp solution, the swollen polymer, after the ignition of the first cell, lay on the burning cell (seat of fire) and was able to prevent the ignition of further cells by providing cooling action. In this case too, however, significant emission of smoke gas was observed. Moreover, fluoride and phosphate ions were also detectable in the extinguishing water.

In the case of use of a combination of an aqueous Firesorp solution and an aqueous calcium chloride solution as the extinguishant, it was found that the cooling performance was much poorer than in the case of sole use of a Firesorp solution. The cause of this is probably a decrease in swellability and hence in the cooling performance of the swellable polymer present in Firesorp because of salting-out of the polymer triggered by the chloride ions in the calcium chloride.

In the case of use of the compositions from Examples 2a to 2f, the swollen polymer lay on the burning cell (seat of fire) and was able to prevent the ignition of further cells by providing cooling action. Compared to the fire tests with carbon dioxide, metal fire powder, water, pure Firesorp solution and the Firesorp-calcium chloride solution combination as extinguishants, the compositions from Examples 2a to 2f resulted in observation of significantly better smoke gas abatement and significantly lower smoke gas emission. The composition from Example 2c shows the best results of Examples 2a to 2c, and the composition from Example 2f achieved the best results from Examples 2d to 2f. After extinguishing with the compositions from Examples 2a to 2f, no fluoride and phosphate ions were detected in the extinguishing water.

1. A fire-extinguishing and/or fire-retardant composition, comprising:
at least one swellable polymer; and
at least one alkaline earth metal carboxylate of one or more carboxylic acids.

2. The composition as claimed in claim 1, wherein the at least one alkaline earth metal carboxylate includes one or more identical or different carboxylate groups selected from the group consisting of lactate, gluconate, citrate, oxalate and tartrate.

3. The composition as claimed in claim 1, wherein the at least one alkaline earth metal carboxylate is selected from the group consisting of calcium lactate gluconate, calcium lactate, calcium gluconate, calcium citrate, calcium oxalate, calcium tartrate and combinations thereof, especially calcium lactate gluconate, calcium lactate, calcium gluconate and combinations thereof.

4. The composition as claimed in claim 1, wherein the composition includes at least one swellable polymer having carboxyl groups, at least some of the carboxyl groups neutralized with alkaline earth metal ions.

5. The composition as claimed in claim 4, wherein the carboxyl groups are at least partly neutralized with calcium ions.

6. The composition as claimed in claim 1, wherein the composition includes at least one alkaline earth metal ion-neutralized polymer based on at least one of acrylic acid and acrylic acid derivatives.

7. The composition as claimed in claim 1, wherein the composition includes at least one at least partly alkaline earth metal ion-neutralized acrylic acid-acrylamide copolymer.

8. The composition as claimed in claim 1, further comprising at least one antiseparation agent and/or thickener.

9. The composition as claimed in claim 1, further comprising at least one foaming agent.

10. The composition as claimed in claim 1, further comprising water.

11. The composition as claimed in claim 1, wherein the at least one swellable polymer and the at least one alkaline earth metal carboxylate of one or more carboxylic acids are mixed.

12. The composition as claimed in claim 1, wherein the composition is configured to at least one of fight fire and produce a fire-retardant coating.

13. The composition as claimed in claim 1, configured to be used in a stationary or mobile extinguishing apparatus.

14. A lithium ion battery, comprising:
a composition configured to at least one of extinguish and retard fire, the composition including:
at least one swellable polymer; and
at least one alkaline earth metal carboxylate of one or more carboxylic acids.

15. A stationary or mobile extinguishing apparatus, the apparatus comprising:
a composition configured to at least one of extinguish and retard fire, the composition including:
at least one swellable polymer; and
at least one alkaline earth metal carboxylate of one or more carboxylic acids.

16. The composition as claimed in claim 1, wherein the at least one alkaline earth metal carboxylate of one or more carboxylic acids is calcium carboxylate.

17. The composition as claimed in claim 6, wherein the at least one alkaline earth metal ion-neutralized polymer based on at least one of acrylic acid and acrylic acid derivatives is crosslinked.

18. The composition as claimed in claim 11, wherein the at least one alkaline earth metal carboxylate of one or more carboxylic acids is calcium carboxylate.

19. The composition as claimed in claim 12, wherein the composition is configured for firefighting and/or fire retardance of fires of fluorine- and/or phosphorous-containing materials, for example for fires involving hydrogen fluoride and/or phosphorous oxide trifluoride evolution, for example for fires of lithium ion batteries.

20. The composition as claimed in claim 13, wherein the composition is configured to be used in or for a vehicle, in or for a lithium ion battery, in or for a lithium ion battery manufacturing, assembly and/or testing plant, and/or in or for a lithium ion battery vessel, for example a transport vessel.
